(19) United States
(12) Patent Application Publication
(10) Pub. No.: US 2015/0199267 A1
(43) Pub. Date: Jul. 16, 2015

(54) MEMORY CONTROLLER, SYSTEM COMPRISING MEMORY CONTROLLER, AND RELATED METHODS OF OPERATION

(71) Applicants: EUN-CHU OH, HWASEONG-SI (KR); CHANG-KYU SEOL, OSAN-SI (KR); JUN-JIN KONG, YONGIN-SI (KR); JONG-HA KIM, SEONGNAM-SI (KR); HONG-RAK SON, ANYANG-SI (KR)

(72) Inventors: EUN-CHU OH, HWASEONG-SI (KR); CHANG-KYU SEOL, OSAN-SI (KR); JUN-JIN KONG, YONGIN-SI (KR); JONG-HA KIM, SEONGNAM-SI (KR); HONG-RAK SON, ANYANG-SI (KR)

(21) Appl. No.: 14/323,294

(22) Filed: Jul. 3, 2014

(30) Foreign Application Priority Data
Jan. 15, 2014 (KR) 10-2014-0005184

(51) Int. Cl. G06F 12/02; G06F 11/10; G06F 3/06

(52) U.S. Cl. CPC G06F 12/0238; G06F 3/0619; G06F 3/0644; G06F 3/0679; G06F 11/1072; G06F 2212/1008; G06F 2212/1032; G06F 2212/202; G06F 2212/403

(57) ABSTRACT

A method of operating a memory controller comprises receiving original data from an external source, partitioning the original data into multiple elements of unit data, changing an order of at least one element of unit data to reduce the number of occurrences of a target state among the multiple units of unit data, and controlling a non-volatile memory device to program the multiple elements of unit data having the reduced number of occurrences of the target state.

### CROSS-REFERENCE TO RELATED APPLICATION

This application claims priority under 35 U.S.C. §119 to Korean Patent Application No. 10-2014-0005184 filed on Jan. 15, 2014, the subject matter of which is hereby incorporated by reference.

### BACKGROUND OF THE INVENTION

The inventive concept relates generally to memory controllers, memory systems comprising a memory controller, and related methods of operation.

Many modern electronic systems require large amounts of data storage in the form of non-volatile memory. Accordingly, researchers have devoted significant resources to the development of high storage capacity non-volatile memory devices.

One way to increase the storage capacity of non-volatile memory devices is through device miniaturization. As non-volatile memory devices become increasingly small, however, their reliability tends to decrease. This decrease in reliability can be managed by identifying memory cells that perform poorly (e.g., those that leak charges), and avoiding the use of those memory cells. In performing management operations, however, a balance must be struck between designating memory cells as defective, and retaining the use of cells that may be at risk of failure.

### SUMMARY OF THE INVENTION

In one embodiment of the inventive concept, a method of operating a memory controller comprises receiving original data from an external source, partitioning the original data into multiple elements of unit data, changing an order of at least one element of unit data to reduce the number of occurrences of a target state among the multiple units of unit data, and controlling a non-volatile memory device to program the multiple elements of unit data having the reduced number of occurrences of the target state.

In another embodiment of the inventive concept, a method is provided for operating a memory controller that controls a multi-level cell (MLC) non-volatile memory device. The method comprises receiving original data from an external source, partitioning the original data into multiple units of page data, selecting the units of page data and combining the selected units to reduce a number of target data patterns among the units of page data, and controlling the non-volatile memory device to program the combined units of page data.

In yet another embodiment of the inventive concept, a method is provided for operating a memory controller that controls a three dimensional non-volatile memory device. The method comprises partitioning original data from a host into multiple units of page data, rearranging an order of the page data to reduce the number of occurrences of a target data pattern, and providing the non-volatile memory device with the rearranged page data.

In still another embodiment of the inventive concept, a memory controller comprises a microprocessor, a random access memory (RAM) configured to store original data and parameters used by the microprocessor, and a page management unit configured to partition the original data into multiple unit data and change an order of at least one element of unit data to reduce the number of occurrences of a target state. Under the control of the microprocessor, changed data is used for performing address mapping.

In still another embodiment of the inventive concept, a page management unit comprises a buffer configured to temporarily store original data to be stored in a non-volatile memory device, a partitioning component configured to partition the original data into multiple elements of unit data, and a reordering component configured to change an order of at least one element of unit data to reduce the number of occurrences of a target state among the multiple units of unit data.

These and other embodiments of the inventive concept can potentially improve the reliability of stored data in non-volatile memory devices through the use of data reordering.

### BRIEF DESCRIPTION OF THE DRAWINGS

The drawings illustrate selected embodiments of the inventive concept. In the drawings, like reference numbers indicate like features.

FIG. 1 is a block diagram illustrating a memory system in accordance with an embodiment of the inventive concept.

FIG. 2 shows program and erase threshold voltage distributions of a 4-bit multi-level cell (MLC) non-volatile memory device according to an embodiment of the inventive concept.

FIG. 3 is a block diagram of a memory controller illustrated in FIG. 1 according to an embodiment of the inventive concept.

FIG. 4A is a conceptual diagram illustrating a method of operating a page management unit according to an embodiment of the inventive concept.

FIG. 4B is another conceptual diagram illustrating the method of FIG. 4A according to an embodiment of the inventive concept.

FIG. 5A is a conceptual diagram illustrating a method of operating a page management unit according to an embodiment of the inventive concept.

FIG. 5B is another conceptual diagram illustrating the method of FIG. 5A according to an embodiment of the inventive concept.

FIG. 6A is a conceptual diagram illustrating a method of operating a page management unit according to an embodiment of the inventive concept.

FIG. 6B is another conceptual diagram illustrating the method of FIG. 6A according to an embodiment of the inventive concept.

FIG. 7A is a conceptual diagram illustrating a method of operating a page management unit according to an embodiment of the inventive concept.

FIG. 7B is another conceptual diagram illustrating the method of FIG. 7A according to an embodiment of the inventive concept.

FIG. 8 is a diagram illustrating a criterion for changing the order of unit data according to an embodiment of the inventive concept.

FIG. 9A is a conceptual diagram illustrating a method of operating a page management unit according to an embodiment of the inventive concept.

FIG. 9B is another conceptual diagram illustrating the method of FIG. 9A according to an embodiment of the inventive concept.

FIG. 10 is a flowchart illustrating a method of operating a page management unit according to an embodiment of the inventive concept.

FIG. 11 is a flowchart illustrating a method of operating a page management unit according to another embodiment of the inventive concept.

FIG. 12 is a diagram illustrating a memory cell array in FIG. 1 according to an embodiment of inventive concept.

FIG. 13 is a perspective view of a part of a memory block in FIG. 12 according to an embodiment of inventive concept.

FIG. 14 is a cross-sectional view taken along a line XV-XV′ of FIG. 13.

FIG. 15 is an equivalent circuit diagram of a memory block described with reference to FIGS. 12 through 14.

FIG. 16 is a diagram illustrating an electronic device according to an embodiment of inventive concept.

FIG. 17 is a diagram illustrating an electronic device according to an embodiment of inventive concept.

FIG. 18 is a diagram illustrating an electronic device according to an embodiment of inventive concept.

FIG. 19 is a diagram illustrating an electronic device according to an embodiment of inventive concept.

FIG. 20 is a diagram illustrating an electronic device according to an embodiment of inventive concept.

FIG. 21 is a diagram illustrating an electronic device according to an embodiment of inventive concept.

### DETAILED DESCRIPTION OF EMBODIMENTS

Embodiments of the inventive concept are described below with reference to the accompanying drawings. These embodiments are presented as teaching examples and should not be construed to limit the scope of the inventive concept.

In the description that follows, the terms first, second, etc. may be used to describe various elements, but these elements should not be limited by these terms. Rather, these terms are used merely to distinguish one element from another. For example, a first element could be termed a second element, and, similarly, a second element could be termed a first element, without departing from the scope of this disclosure. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

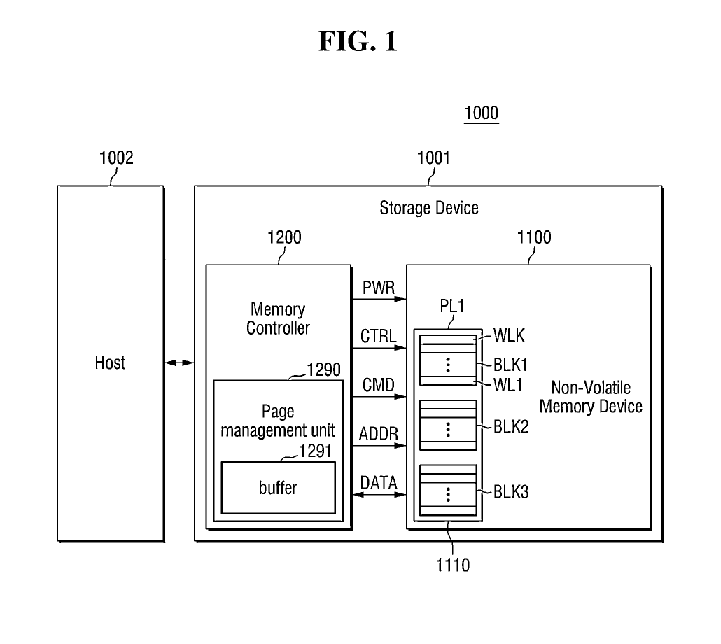

FIG. 1 is a block diagram illustrating a memory system 1000 in accordance with an embodiment of the inventive concept. Memory system 1000 can be embodied by an electronic device, such as a mobile phone, a smart phone, a tablet, a PC, a personal digital assistant (PDA), an enterprise digital assistant (EDA), a digital still camera, a digital video camera, a portable multimedia player (PMP), a personal navigation device or portable navigation device (PDN), a handled game console, or an e-book, for example.

Referring to FIG. 1, memory system 1000 comprises a storage device 1001 and a host 1002. Storage device 1001 comprises a non-volatile memory device 1100 and a memory controller 1200. Host 1002 provides original data to memory controller 1200.

Memory controller 1200 controls non-volatile memory device 1100. Non-volatile memory device 1100 can perform an erase, program or read operation under the control of memory controller 1200. To perform these operations, non-volatile memory device 1100 receives a command CMD, an address ADDR and data DATA through an input/output line. Non-volatile memory device 1100 receives power through a power line and a control signal CTRL through a control line. Control signal CTRL may comprise a command latch enable CLE, an address latch enable ALE, a chip enable nCE, a write enable nWE, a read enable nRE, etc.

Non-volatile memory device 1100 may comprise a flash memory, an electrically erasable programmable read only memory (EEPROM), a ferroelectric random access memory (FRAM), a phase change RAM (PRAM), a magneto resistive RAM (RAM), etc. A NAND flash memory device is illustrated in FIG. 1, but the inventive concept is not limited to this example.

Non-volatile memory device 1110 comprises multiple cell arrays configured to store data. Each of the cell arrays may include multiple planes such as PL1. Plane PL1 comprises multiple blocks BLK1 through BLKm. In FIG. 1, PL1 is described below by way of example, for purposes of illustration. Each of blocks BLK1 through BLKm comprises multiple word lines such as word line 1 (WL1) through word line K (WLk). Each of blocks BLK1 through BLKm may be a unit for executing an erase command, that is, a unit on which an erase operation is simultaneously performed. Each of the word lines may be a unit for executing a program and a read command, that is, a unit on which a program and a read operation are simultaneously performed. Multiple blocks may include three dimensional structure where memory cells are stacked on a substrate.

As a space between memory cells is reduced due to miniaturization, non-volatile memory device 1100 may experience reduced reliability that varies according to data pattern. For example, storage of certain data patterns may produce electrical effects that distort the stored data. Potential causes of such degradation may be, for example, charge loss, back pattern dependency, and coupling. Phenomena such as charge loss, back pattern dependency, and coupling may be ameliorated by avoiding data patterns that decrease reliability, which can be done by modifying data to be programmed.

Non-volatile memory device 1100 comprises multiple programmed states. Memory controller 1200 may improve reliability of non-volatile memory 1100 device by reducing the number of an uppermost programmed state or an erased state, for example. The state(s) to be reduced will be referred to as a target state(s). Memory controller 1200 may partition original data into multiple units of data and change an order of at least one unit of data to reduce the target state. This reduction of the target state may improve the reliability of non-volatile memory device 1100.

Memory controller 1200 comprises a page management unit 1290 configured to change an order of original data and adjust data pattern of page unit data. Page management unit 1290 comprises buffer 1291 configured to temporarily store original data.

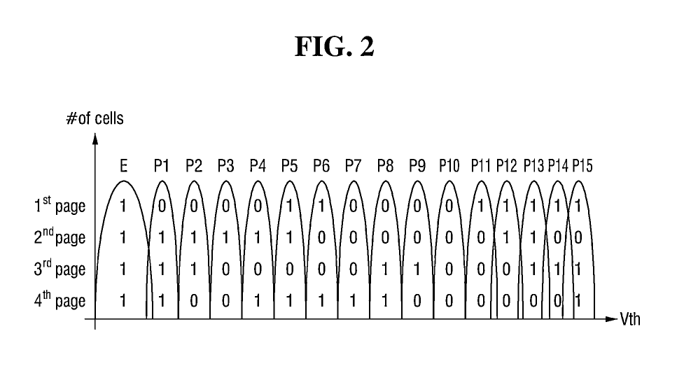

FIG. 2 illustrates program and erase threshold voltage distributions of a 4-bit MLC non-volatile memory device according to an embodiment of the inventive concept. In FIG. 2, the ‘X’ axis indicates threshold voltage and ‘Y’ axis indicates the number of cells. In general, a memory cell may store k bits of data using 2^{k} threshold voltage distributions. Accordingly, in the example of FIG. 2, 4-bit data is stored using 2⁴=16 threshold voltage distributions.

Referring to FIG. 2, the 16 threshold voltage distributions represent 16 data states of 4-bit memory cells, including an erased state (E) and fifteen programmed states P1 through P15. Over time, adjacent states start to overlap each other after programming because of a charge loss, a program disturbance, an erase disturbance, and a back pattern dependency. Additionally, programmed states with relatively high threshold voltages, such as programmed states P13 through P15, may induce a charge loss or a program disturbance and decrease the reliability of non-volatile memory device.

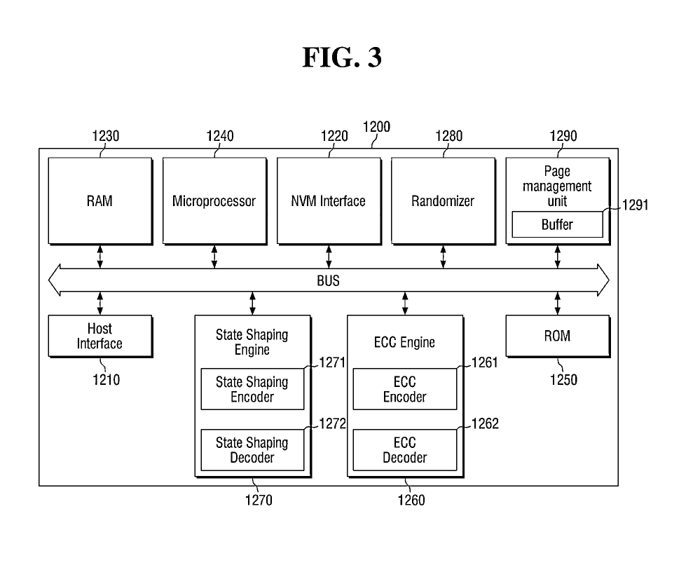

FIG. 3 is a block diagram of memory controller 1200 illustrated in FIG. 1 according to an embodiment of the inventive concept.

Referring to FIG. 3, memory controller 1200 comprises a host interface 1210, a non-volatile memory interface 1220, a RAM 1230, a microprocessor 1240, a read only memory (ROM) 1250, an ECC engine 1260, a state shaping engine 1270 and a page management unit 1290. The above features of memory controller 1200 can be connected to one another through a bus.

Host interface 1210 provides an interface between storage device 1001 including memory controller 1200 and host 1002 according to a predetermined protocol. Host interface 1210 can communicate with an external host through a universal serial bus (USB), a small computer small interface (SCSI), peripheral component interconnection (PCI), a advanced technology attachment (ATA), a parallel-ATA (PATA), serial-ATA (SATA), or serial attached SCSI (SAS), for example.

Non-volatile memory interface 1220 provides an interface between memory controller 1200 and non-volatile memory device 1100. A command required by microprocessor 1240 can be provided to non-volatile memory device 1100 through non-volatile memory interface 1220. Data can be transmitted from memory controller 1200 to non-volatile memory device 1100. Data provided from non-volatile memory device 1100 is provided to memory controller 1200 through non-volatile memory interface 1220.

RAM 1230 functions as a buffer. RAM 1230 can store the first command, data, and other information received through host interface 1210 or output data from non-volatile memory device 1100. RAM 1230 can store data or other information input to and output from non-volatile memory device 1100. RAM 1230 can drive state shaping mapping information that provides information of a change section of data to be programmed to non-volatile memory device 1100.

Microprocessor 1240 can be embodied by a circuit, logic, code or combinations thereof. Microprocessor 1240 controls operation of storage device 1001 including memory controller 1200. If power is applied to storage device 1001, microprocessor 1240 can control an overall operation of memory system 1000 by driving firmware for an operation of memory system 1000 stored in ROM 1250 on RAM 1230. Microprocessor 1240 can interpret a command being applied from the host to control an overall operation of non-volatile memory device 1100 according to an interpretation result. Moreover, microprocessor 1240 is configured to perform address mapping which means that logical address from the host adjust to physical address for non-volatile memory device. ROM 1250 can store a drive firmware code of storage device 1001 and codes necessary for an operation of memory controller 1200. However, the inventive concept is not limited thereto. The firmware code may be stored in various types of non-volatile memory devices 1100, for example, a flash memory device, besides ROM 1250. Control or intervention of microprocessor 1240 can include not only direct hardware control of microprocessor 1240 but also intervention of a firmware which is a software being driven by microprocessor 1240.

In a 4-bit MLC flash memory device, non-volatile memory device 1100 may comprise four logical pages, fifteen program states P1˜P15 and an erase state E. In case of performing a state shaping using four logical pages, a predetermined high-order state is uppermost programmed state, P15.

ECC engine 1260 performs error correction and comprises an ECC encoder 1261 and an ECC decoder 1262. ECC encoder 1261 performs error correction encoding of data to generate a codeword to which parity is added. The codeword can be stored in non-volatile memory device 1100.

ECC decoder 1262 performs an error correction decoding on output data, judges whether the error correction decoding succeeds or not according to a performance result and outputs an indicating signal according to a judgment result. Read data is transmitted to ECC decoder 1262 and ECC decoder 1262 can correct an error bit of the data using parity. If the number of error bits exceeds a limit of correctable error bit, ECC decoder 1262 cannot correct an error bit and thereby an error correct fail occurs.

ECC encoder 1261 and ECC decoder 1262 can perform error correction using one of various forms of coded modulation, such as a low density parity check (LDPC) code, a BCH code, a turbo code, a Reed-Solomon code, a convolution code, a recursive systematic code (RSC), a trellis-coded modulation (TCM), or a block coded modulation (BCM), for example. However, the inventive concept is not limited thereto. Unit data of ECC encoding or decoding operation is sector unit. ECC encoder 1261 and ECC decoder 1262 can include a circuit, a system or a device for an error correction. In case of performing a state shaping operation using ECC encoded data, the ECC encoded data may become original data which is provided to state shaping engine 1270. In addition, a state shaping operation may be performed on original data received from the host and the state shaping encoded data may be provided to ECC encoder 1261.

State shaping engine 1270 comprises a state shaping encoder 1271 and a state shaping decoder 1272. State shaping encoder 1271 encodes original data to avoid a programmed state degrading reliability of non-volatile memory device 1100. Encoded data of which a programmed state is changed may be provided to non-volatile memory device 1100 for a program operation. Encoded data of which a program state is changed may be provided to ECC encoder 1261 and after performing the ECC encoding, may be provided to non-volatile memory device 1100 for a program operation.

State shaping decoder 1272 decodes data received from non-volatile memory device 1100 and provides memory controller 1200 with decoded data. State shaping encoder 1271 performs a state shaping encoding with reference to state shaping mapping information stored in ROM 1250 or non-volatile memory device 1100. The state shaping mapping information can be determined when controller 1200 is manufactured and can be updated after manufacture.

Randomizer 1280 is configured to transfer input data pattern to let the data pattern (i.e. 1 or 0, P1 state, P2 state, P3 state) remain stable at random, i.e., and randomly equalize the data pattern. Randomizer 1280 provides non-volatile memory device 1100 with randomized data, random data.

Where non-volatile memory device 1100 has greater density, interference between memory cells may increase. Neighboring cells' states may increase the interference or decrease the interference. Storing random data may minimize the interference.

Normally, non-volatile memory device 1100 has interferences such as a program voltage disturbance, a pass voltage disturbance, a coupling effect between floating gate and a back pattern dependency effect. The random data programming into non-volatile memory device 1100 may minimize such interferences.

Page management unit 1290 is configured to partition original data into multiple unit data and change an order of at least one unit data to reduce the number of target states. The target state may be a programmed state that degrades the reliability of non-volatile memory device. The target state may include the uppermost programmed state, P15 or multiple high programmed states, P13 through P15, for example. Page management unit 1290 is configured to partition original data into multiple unit data and reduce the number of the uppermost programmed state by changing the order of at least one unit data. Original data may be data directly provided by the host. In addition, original data may be either randomized data by randomizer or ECC encoded data by ECC encoder. And, original data may be state shaping encoded data by state shaping encoder.

Unit data may be sector unit data that is ECC operation unit or page unit data that is unit of program or read operation. In addition, unit data may be randomizing operation unit data. Page management unit 1290 is configured to change the order of data unit based on the number of target states of original data. Furthermore, page management unit 1290 is configured to change the order of data unit based on the numbers of data patterns of partial page of original data. Page management unit 1290 is configured to change the order of data unit based on the number of occurrences of a bit value among the unit data.

Microprocessor 1240 performs an address mapping operation using changed data. The address mapping operation means that logical address is mapped to physical address. Therefore, memory controller 1200 may avoid the addition of parity bits while reducing the number of target states.

Page management unit 1290 may provide state shaping engine 1270 with changed unit data. Thus, state shaping engine 1270 may perform a state shaping operation using rearranged page unit data.

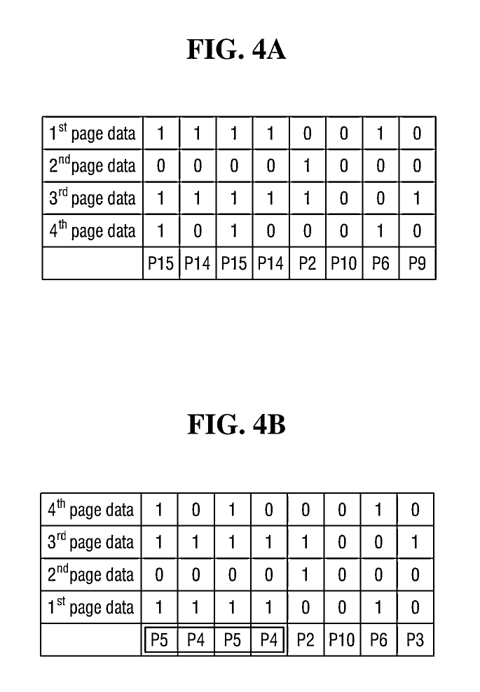

FIGS. 4A and 4B are conceptual diagrams illustrating a method of operating a page management unit according to an embodiment of the inventive concept.

Referring to FIGS. 1 through 4, FIG. 4A indicates original data patterns including four numbers of unit data from original data. The data patterns in FIG. 4A may be stored in 4-bits MLC non-volatile memory device 1100 and unit data means page data of non-volatile memory device 1100. Still referring to FIG. 4A, original data includes at least four kinds of page data. Page management unit 1290 partitions original data into multiple units of page data.

Referring still to FIG. 4A, original data pattern comprises several target states that are uppermost programmed state P15 or high programmed states P14 and P15. Thus, page management unit 1290 may change the order of data and rearrange data. FIG. 4A shows that the first page data and the fourth page data are switched and the second page data and the third data page are switched. As a result, FIG. 4B does not include target state such as P14 or P15. P15 of FIG. 4A is changed into P5 of FIG. 4B and P14 of FIG. 4A is changed into P4 of FIG. 4B. Page management unit 1290 may change the uppermost programmed state P15 and high programmed states P14 and P15 into lower programmed states by changing the order of data. Therefore, the reliability of non-volatile memory device 1100 is improved by reducing the number of the uppermost programmed state.

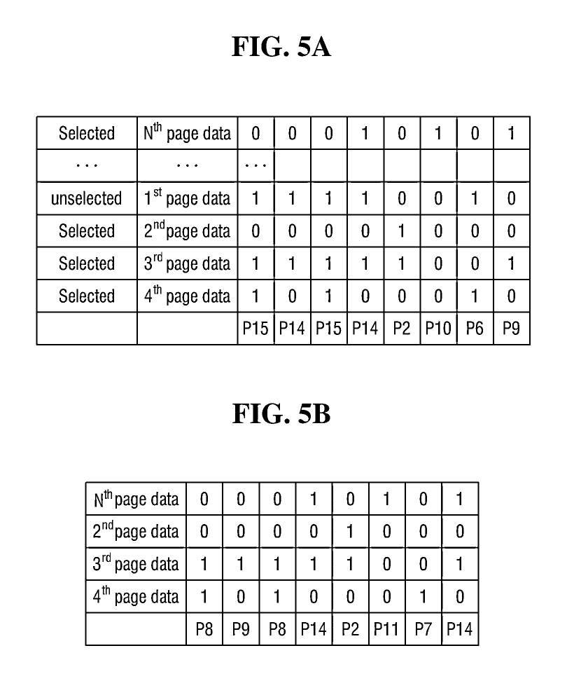

FIGS. 5A and 5B are conceptual diagrams illustrating a method of operating a page management unit according to an embodiment of the inventive concept.

Referring to FIGS. 1 through 5B, FIG. 5A indicates the original data patterns including more than four numbers of unit data. As described with reference to FIG. 4A, unit data is page data. Still referring to FIG. 5A, original data pattern includes several target states which are the uppermost programmed state P15 or high programmed states P14 and P15.

Thus, page management unit 1290 may select the page unit data and combine the selected page unit data to reduce the number of target data patterns. Still referring to FIG. 5A, original data includes at least four kinds of page data. Page management unit 1290 partitions original data into multiple units of page data. And page management unit 1290 selects four kinds of page data among N kinds of page data, N>4 and combines selected pages to reduce the number of target data patterns. Page management unit 1290 may select second page through fourth page and fifth page and rearrange the selected pages. As a result, FIG. 5B does not include target data pattern such as programmed state P15. This tends to improve the reliability of non-volatile memory device 1100 by eliminating the number of the uppermost programmed state that means target data pattern.

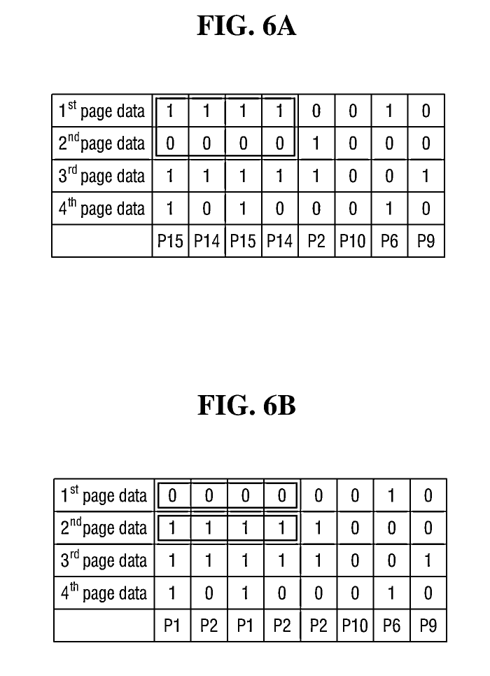

FIGS. 6A and 6B are conceptual diagrams illustrating a method of operating a page management unit according to another embodiment of the inventive concept.

Referring to FIGS. 1 through 6B, FIG. 6A indicates the original data patterns including at least four numbers of unit data. As described in FIG. 4A, unit data is page data. Still referring to FIG. 6A, original data includes at least four kinds of page data. Page management unit 1290 partitions original data into page unit data. Still referring to FIG. 6A, original data pattern includes several target states which are the uppermost programmed state P15 or high programmed states P14 and P15. Thus, page management unit 1290 may rearrange partial data of page unit data.

FIG. 6A shows that the four kinds of first page data and the four kinds of second page data are switched and rearranged. As a result, FIG. 6B does not include target data pattern or target state such as P15 or P14. P15 of FIG. 6A is changed into P1 of FIG. 6B and P14 of FIG. 6A is changed into P2 of FIG. 6B. Page management unit 1290 may change the uppermost programmed state P15 and high programmed states P16 and P15 into lower programmed states by changing the order of partial data of page unit. Therefore, the reliability of non-volatile memory device 1100 is improved by reducing the number of the uppermost programmed state.

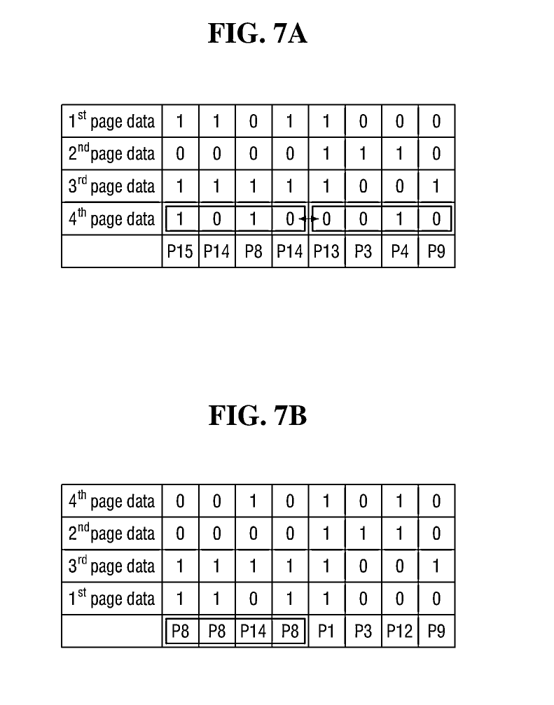

FIGS. 7A and 7B are conceptual diagrams illustrating a method of operating a page management unit according to another embodiment of the inventive concept.

Referring to FIGS. 1 through 7B, FIG. 7A indicates the original data patterns including at least four numbers of unit data. As described in FIG. 7A, unit data is page data. Still referring to FIG. 7A, original data includes at least four kinds of page data. The page management unit partitions original data into page unit data. Still referring to FIG. 7A, original data pattern includes several target states which are the uppermost programmed state P15. Thus, page management unit 1290 may rearrange partial data of page unit data.

Referring to FIG. 7A, the page management unit may perform a circular shift operation of the fourth page data and switch the first page and fourth page. As a result, FIG. 7B does not include target data pattern or target state such as P15 of FIG. 7A.

Page management unit 1290 may eliminate the uppermost programmed state P15 by performing the circular shift operation of partial data of page unit and switching the order of page unit data. Therefore, the reliability of non-volatile memory device 1100 may be improved by reducing the number of the uppermost programmed state.

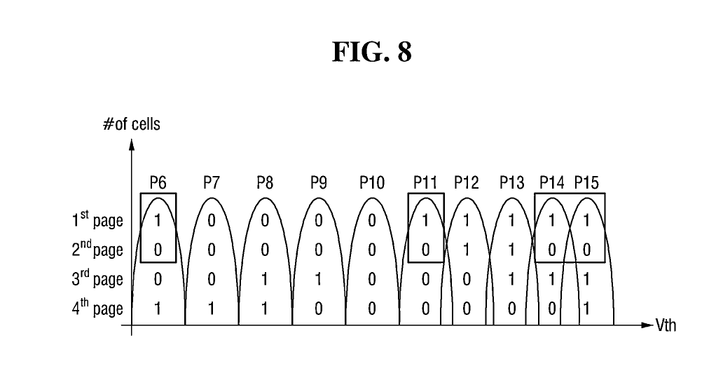

FIG. 8 is a diagram illustrating a criterion for changing the order of unit data according to an embodiment of the inventive concept. FIG. 8 shows partial program and erase threshold voltage distributions of 4-bit MLC non-volatile memory 1100.

Referring to FIG. 8, target states such as P14 or P15 include bit 1 as the first page data and bit 0 as the second page data. Therefore, page management unit 1290 may check the first page data and the second page data of unit data and count the number of data state or data patterns of unit data corresponding to P 14 and P15.

Page management unit 1290 reduces the number of target states by changing the order of unit data according to a result of checking and counting.

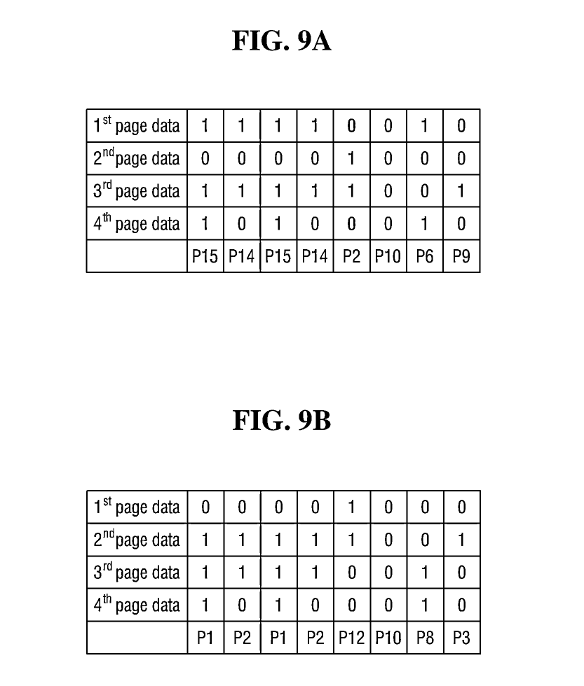

FIG. 9A and 9B are conceptual diagrams illustrating a method of operating a page management unit according to another embodiment of the inventive concept and explaining a criterion for changing the order of unit data according to another embodiment of the inventive concept.

Referring to FIG. 9A original data patterns include at least four numbers of unit data. Unit data is, for example, page data. The original data can at least four kinds of page data. Page management unit 1290 counts the number of occurrences of a bit value. Page management unit 1290 may change the order of page data according to the number of occurrences. For example, in FIG. 9A, the first page includes five occurrences of bit 1, the second page includes one occurrence of bit 1, and the third page includes six occurrences of bit 1. Page management unit 1290 may change the order of page data based on the number of bit 1. Page management unit 1290 may change the third page which includes the most occurrences of bit 1 to the first page data. Then, page management unit 1290 may change the second page data which includes the lowest number of bit 1 to the first page data. FIG. 9B shows a changed data pattern where page data unit changes the order of page data based on the number of bit 1. FIG. 9A includes both P14 and P 15 but, FIG. 9B does not include both P14 and P15. Page management unit 1290 reduces the number of target states by changing the order of unit data based on the number of bit 1, therefore page management unit 1290 improves the reliability of non-volatile memory device.

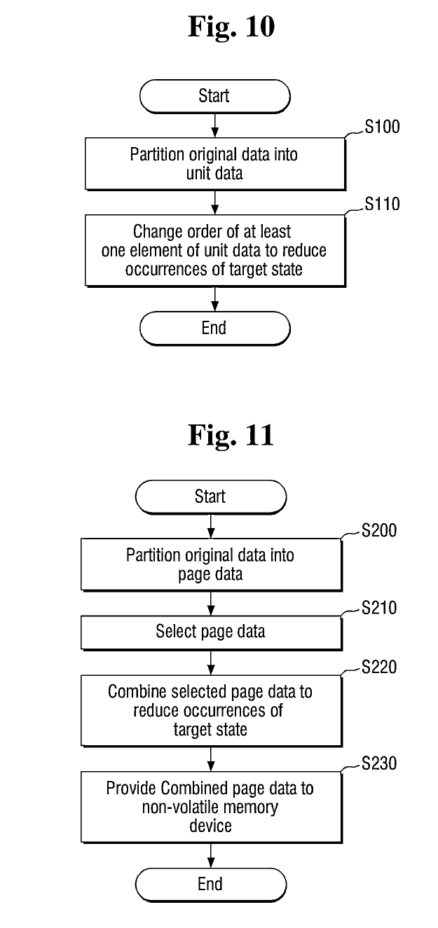

FIG. 10 is a flowchart illustrating a method of operating a page management unit according to an embodiment of the inventive concept.

Referring to FIG. 10, the page management unit partitions original data from the host into multiple unit data (S100). Unit data may be a sector unit data which is ECC operation unit data, page unit data which is program or read operation, or randomizing operation unit data. And original data from the host may be ECC encoded data or randomized data.

Moreover, the page management unit may reduce the number of target states by changing the order of at least one unit data (S110). Therefore, the page management unit may improve the reliability of non-volatile memory device. The target state may be the uppermost programmed state. The memory controller may perform address mapping operation using changed page data. As a result, the memory controller may reduce the number of target states without adding additional parity bits.

FIG. 11 is a flowchart illustrating a method of operating a page management unit according to another embodiment of the inventive concept.

Referring to FIG. 11, the page management unit may partition original data from the host into multiple page unit data (S200). Thereafter, the page management unit may select the page unit data (S210). Then, the page management unit may combine the selected page unit data to reduce the number of target data patterns (S220). Finally, the memory controller may provide non-volatile memory device with combined data (S230). For example, in a 4-bit MLC non-volatile memory device, the page management unit may select four units of page data among original data. The memory controller starts to perform an address mapping operation using the selected page address.

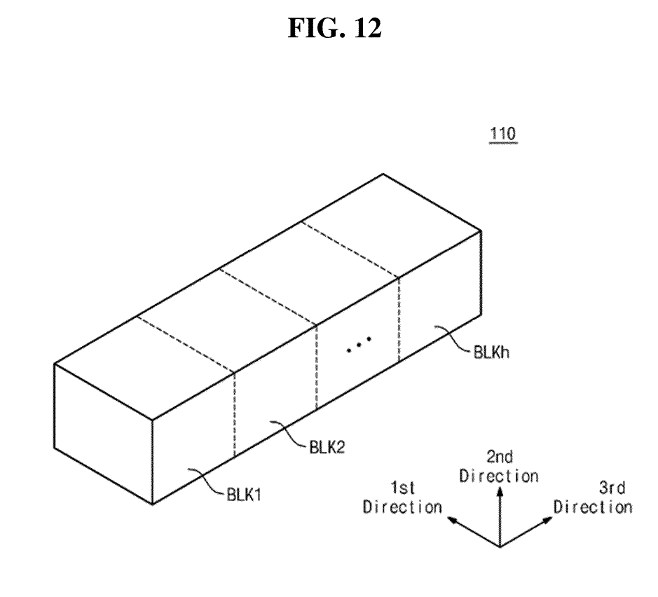

As shown in FIGS. 12 to 15, non-volatile memory device 1100 may have a three-dimensional structure. FIG. 12 is a diagram illustrating a memory cell array in FIG. 1 according to an embodiment of inventive concept. Referring to FIG. 12, a memory cell array may include multiple memory blocks BLK1 through BLKh, each formed with a three-dimensional structure (or, a vertical structure). For example, each of the memory blocks BLK1 through BLKh may include structures extending along first to third directions.

Each of memory blocks BLK1 through BLKh may include multiple NAND strings extending along the second direction. For example, multiple NAND strings NS may be provided along the first and third directions. Each NAND string NS may be connected to a bit line, at least one string selection line, at least one ground selection line, word lines, and a common source line. That is, each memory block may be connected to multiple bit lines, multiple string selection lines, multiple ground selection lines, multiple dummy word lines, and multiple common source lines. Each memory block will be more fully described with reference to FIG. 12 through FIG. 15.

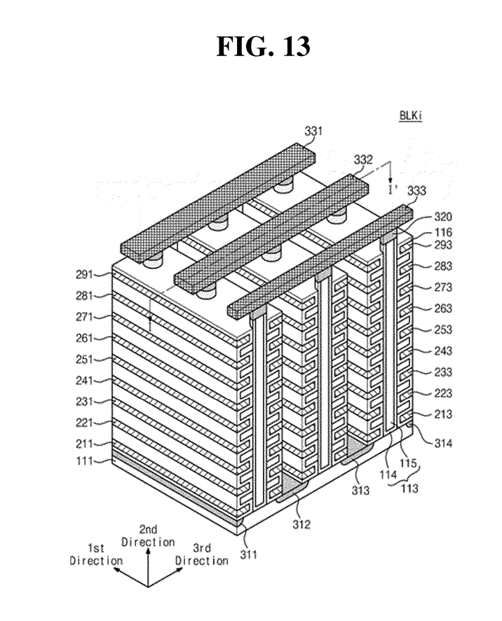

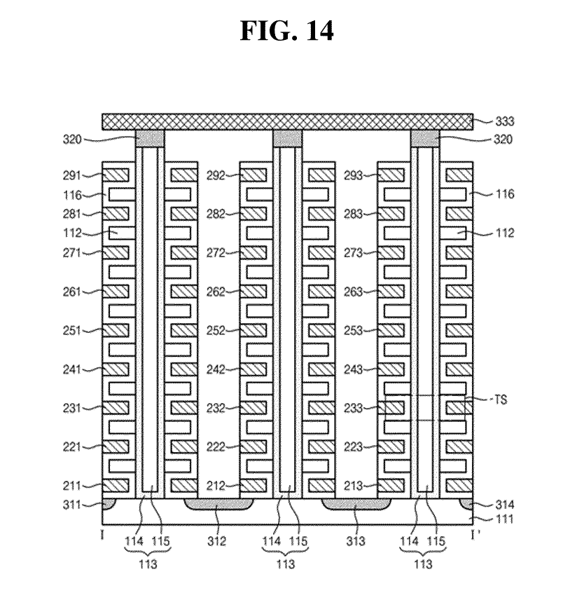

FIG. 13 is a perspective view of a part of a memory block in FIG. 12 according to an embodiment of inventive concept, and FIG. 14 is a cross-sectional view taken along a line XV-XV′ of FIG. 13. Referring to FIGS. 13 and 14, a memory block BLKi may include structures that extend along first to third directions.

First, a substrate 111 is provided. In some embodiments, substrate 111 may include a silicon material doped with a first-type impurity. For example, substrate 111 may be a silicon material doped with a p-type impurity or a p-well (or, a pocket p-well), and may further include an n-well surrounding the p-well. Below, it is assumed that substrate 111 is p-type silicon, although substrate 111 is not limited thereto.

Multiple doping regions 311 through 314 extending along the first direction may be provided at substrate 111. For example, multiple doping regions 311 through 314 (hereinafter, first through fourth doping regions) may be n-type. Hereinafter, it is assumed that the first through fourth doping regions 311 through 314 are n-type, although they are not limited thereto.

On substrate 111 between the first and second doping regions 311 and 312, multiple insulating materials 112 extending along the first direction may be sequentially provided along the second direction. For example, insulating materials 112 and substrate 111 may be spaced apart along the second direction. For example, insulating materials 112 may be formed to be separated by a desired (or alternatively predetermined) distance along the second direction. In some embodiments, insulating materials 112 may include an insulating material such as silicon oxide.

On substrate 111 between first and second doping regions 311 and 312, multiple pillars 113 may be provided which are sequentially disposed along the first direction and pass through insulating materials 112 along the second direction. In some embodiments, pillars 113 may contact with substrate 111 through insulating materials 112, respectively.

In some embodiments, each of pillars 113 may be formed of multiple materials. For example, a surface layer 114 of each pillar 113 may include a first-type silicon material. For example, surface layer 114 of each pillar 113 may include a silicon material doped with the same type as substrate 111. Hereinafter, it is assumed that surface layer 114 of each pillar 113 includes p-type silicon. However, surface layer 114 of each pillar 113 is not limited thereto.

An inner layer 115 of each pillar 113 may be formed of an insulating material. For example, inner layer 115 of each pillar 113 may include an insulating material such as silicon oxide, but embodiments of inventive concept are not limited thereto.

Between the first and second doping regions 311 and 312, an insulating film 116 is provided along exposed surfaces of substrate 111, insulating materials 112, and pillars 113. For example, the thickness of insulating film 116 may be less than half a distance between insulating materials 112. That is, a region where a material other than insulating materials 112 and insulating film 116 is disposed may be provided between an insulating film 116 provided on a lower surface of a first insulating material among insulating materials 112 and an insulating film 116 provided on an upper surface of a second insulating material and at the lower portion of the first insulating material.

Between the first and second doping regions 311 and 312, conductive materials 211 through 291 may be provided on an exposed surface of insulating film 116. For example, a conductive material 211 extending along the first direction may be provided between substrate 111 and insulating material 112 adjacent to substrate 111. In detail, conductive material 211 extending along the first direction may be provided between substrate 111 and insulating film 116 at a lower surface of the insulating material adjacent to substrate 111.

A conductive material extending along the first direction may be provided between insulating film 116 on an upper surface of a specific insulating material of insulating materials 112 and insulating film 116 on a lower surface of an insulating material disposed at a top of the specific insulating material.

Multiple conductive materials 221 through 281 extending along the first direction may be provided among insulating materials 112. Further, a conductive material 291 extending along the first direction may be provided on insulating materials 112. In some embodiments, conductive materials 211 through 291 may be a metal material. For example, conductive materials 211 through 291 may be a conductive material such as polysilicon.

The same structure as that on the first and second doping regions 311 and 312 may be provided between the second and third doping regions 312 and 313. Between the second and third doping regions 312 and 313, there may be provided insulating materials 112 extending along the first direction, pillars 113 sequentially disposed in the first direction and passing through insulating materials 112 along the second direction, insulating film 116 provided on exposed surfaces of pillars 113 and insulating materials 112, and conductive materials 212 through 292 extending along the first direction.

The same structure as that on the first and second doping regions 311 and 312 may be provided between the third and fourth doping regions 313 and 314. Between the third and fourth doping regions 313 and 314, there may be provided insulating materials 112 extending along the first direction, pillars 113 sequentially disposed in the first direction and passing through insulating materials 112 in the third direction, insulating film 116 provided on the exposed surfaces of insulating materials 112 and pillars 113, and first conductive materials 213 through 293 extending along the first direction.

Drains 320 may be provided on pillars 113, respectively. In some embodiments, drains 320 may include a second-type silicon material. For example, drains 320 may be n-type silicon material. Hereinafter, it is assumed that drains 320 include n-type silicon material. However, drains 320 are not limited thereto. In some embodiments, a width of each drain 320 may be wider than that of a corresponding pillar 113. For example, each drain 320 may be provided on a corresponding pillar 113 to have a pad shape.

Conductive materials 331 through 333 extending along the third direction may be provided on drains 320. Conductive materials 331 through 333 may be sequentially disposed along the first direction. Conductive materials 331 through 333 may be connected to drains 320 of corresponding regions, respectively. In some embodiments, drains 320 and second conductive material 333 extending along the third direction may be connected through contact plugs. In some embodiments, conductive materials 331 through 333 may be a metal material. For example, conductive materials 331 through 333 may be a conductive material such as polysilicon.

In FIGS. 13 and 14, each pillar 113 may form a string together with an adjacent region of an insulating film 116 and an adjacent region among conductive lines 211 through 291, 212 through 292, and 213 through 293 extending along the first direction. For example, each pillar 113 may form a NAND string NS together with an adjacent region of an insulating film 116 and an adjacent region among conductive lines 211 through 291, 212 through 292, and 213 through 293 extending along the first direction. NAND string NS may include multiple transistor structures TS.

A p-type silicon surface layer 114 of a pillar 113 may act as a body. First sub-insulating film 117 may act as a tunneling insulating film. For example, first sub-insulating film 117 adjacent to pillar 113 may include a thermal oxide layer.

Second sub-insulating film 118 may act as a charge storage film. For example, second sub-insulating film 118 may act as a charge trap layer. For example, second sub-insulating film 118 may include a nitride layer or a metal oxide layer (e.g., an aluminum oxide layer, a hafnium oxide layer, or the like).

Third sub-insulating film 119 adjacent to a first conductive material 233 may act as a blocking insulating film. In some embodiments, third sub-insulating film 119 adjacent to a conductive material 233 extending along a first direction may be a single layer or a multi-layer. Third sub-insulating film 119 may be a high dielectric layer (e.g., an aluminum oxide layer or a hafnium oxide layer) having a larger dielectric constant compared with the first and second sub-insulating films 117 and 118.

Conductive material 233 may serve as a gate (or a control gate). That is, conductive material 233 serving as a gate (or a control gate), third sub-insulating film 119 serving as the blocking insulating film, second sub-insulating film 118 serving as the charge storage layer, first sub-insulating film 117 serving as the tunneling insulation layer, and the p-type surface layer 114 serving as a body may form a transistor (or, a memory cell transistor structure). In some embodiments, first through third sub-insulating films 117 through 119 may form oxide-nitride-oxide (ONO). Below, it is assumed that the p-type surface layer 114 of pillar 113 serves as a second-direction body.

A memory block BLKi may include multiple pillars 113. That is, memory block BLKi may include multiple NAND strings NS. In detail, memory block BLKi may include multiple NAND strings NS extending along a second direction (or, a direction vertical to a substrate). Each NAND string NS may include multiple transistor structures TS that are disposed along a second direction. At least one of transistor structures TS of each NAND string NS may serve as a string selection transistor SST. At least one of transistor structures TS of each NAND string NS may serve as a ground selection transistor GST.

Gates (or control gates) may correspond to conductive materials 211 through 291, 212 through 292, and 213 through 293 extending along a first direction. That is, the gates (or the control gates) may be extended in the first direction to form two selection lines (e.g., at least one string selection line SSL and at least one ground selection line GSL) and word lines extending along the first direction.

Conductive materials 331 through 333 extending in a third direction may be connected to one ends of NAND strings NS, respectively. Conductive materials 331 through 333 may act as bit lines BL. In memory block BLK1, one bit line may be connected with multiple NAND strings.

Second-type doping regions 311 through 314 extending in the first direction may be provided to other ends of NAND strings NS, respectively. The second-type doping regions 311 through 314 may serve as common source lines CSL.

As indicated by the foregoing, memory block BLKi may include multiple NAND strings that extend in a direction (i.e., the second direction) vertical to substrate 111, and may be a NAND flash memory block (e.g., a charge trap type) in which multiple NAND strings NS may be connected to one bit line BL.

FIGS. 12 to 15 were described under the assumption that first conductive lines 211 through 291, 212 through 292, and 213 through 293 extending along the first direction are formed at nine layers. However, embodiments of inventive concept are not limited thereto. For example, conductive lines extending along the first direction may be provided at 8, 16, or plural layers. That is, one NAND string may include 8, 16, or plural transistors.

FIGS. 13 through 14 were described under the assumption that three NAND strings NS are connected to a bit line. However, embodiments of inventive concept are not limited thereto. In some embodiments, in a memory block BLKi, “m” NAND strings NS may be connected to a bit line BL. The number of conductive materials 211 through 291, 212 through 292, and 213 through 293 extending along the first direction and the number of common source lines 311 through 314 may be adjusted according to the number of NAND strings NS connected to a bit line BL.

FIGS. 13 through 14 were also described under the assumption that three NAND strings NS are connected to a conductive material extending along the first direction. However, embodiments of inventive concept are not limited thereto. For example, “n” NAND strings NS may be connected to a conductive material extending along the first direction. The number of bit lines 331 through 333 may be adjusted according to the number of NAND strings connected to a bit line extending along the first direction.

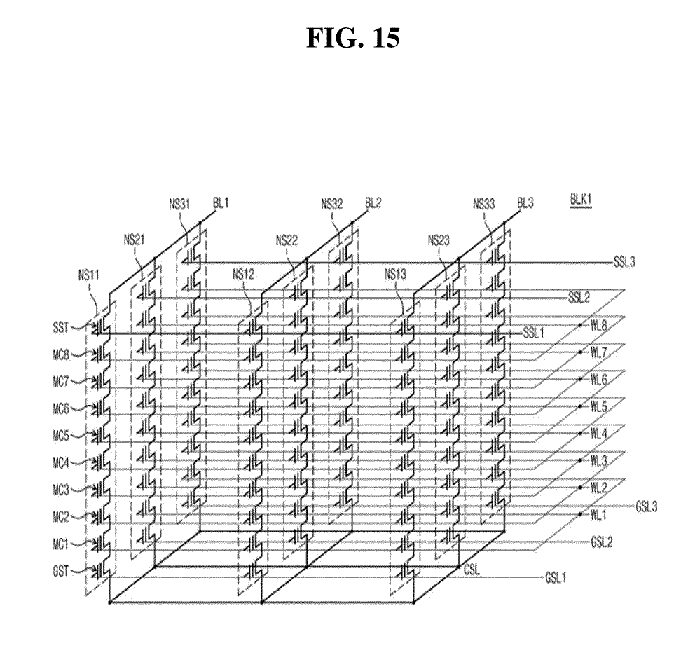

FIG. 15 is an equivalent circuit diagram of a memory block described with reference to FIGS. 12 through 14. Referring to FIGS. 13 through 15, NAND strings NS11, NS21, and NS31 may be provided between a first bit line BL1 and a common source line CSL. NAND strings NS12, NS22, and NS32 may be provided between a second bit line BL2 and common source line CSL. NAND strings NS13, NS23, and NS33 may be provided between a third bit line BL3 and common source line CSL. The first through third bit lines BL1 through BL3 may correspond to conductive material 331 through 333 extending in the third direction, respectively.

A string selection transistor SST of each NAND string NS may be connected to a corresponding bit line BL. A ground selection transistor GST of each NAND string NS may be connected to common source line CSL. In each NAND string NS, memory cells MC may be provided between the string selection transistor SST and the ground selection transistor GST.

Below, NAND strings NS may be defined by the row and by the column. NAND strings NS connected to one bit line in common may form one column. For example, NAND strings NS11 through NS31 connected to the first bit line BL1 may correspond to a first column. NAND strings NS12 through NS32 connected to second bit line BL2 may correspond to a second column. NAND strings NS13 through NS33 connected to third bit line BL3 may correspond to a third column. NAND strings NS connected to one string selection line SSL may form one row. For example, NAND strings NS11 through NS13 connected to a first string selection line SSL1 may form a first row. NAND strings NS21 through NS23 connected to a second string selection line SSL2 may form a second row. NAND strings NS31 through NS33 connected to a third string selection line SSL3 may form a third row.

In each NAND string NS, a height may be defined. In some embodiments, in each NAND string NS, a memory cell MC1 adjacent to the ground selection transistor GST may be defined to have a height of 1. In each NAND string NS, a height of a memory cell may increase in inverse proportion to a distance from a string selection transistor SST. In each NAND string NS, a memory cell MC7 adjacent to the string selection transistor SST may be defined to have a height of 7.

NAND strings in the same row may share the string selection line SSL. NAND strings in different rows may be connected to different string selection lines SSL1, SSL2, and SSL3, respectively.

In each NAND string NS in the same row, memory cells having the same height may share a word line WL. At the same height, word lines WL connected to memory cells of NAND strings in different rows may be connected in common. The word line WL may be configured to be the memory cell layer. The block includes multiple memory cell layers stacked on a substrate and are electrically connected with other word lines Thus, treating the word line connected to the bad memory cell as the bad area may be treating the memory cell layer including the bad memory cell as the bad area.

In the same row of NAND strings NS, ground selection transistors GST may share a ground selection line GSL. In different rows of NAND strings NS, ground selection transistors GST may share the ground selection line GSL. That is, NAND strings NS11 through NS13, NS21 through NS23, and NS31 through NS33 may be connected in common to the ground selection line GSL.

Common source line CSL may be connected in common to NAND strings NS. For example, first through fourth doping regions 311 through 314 may be interconnected at an active region of a substrate 111. For example, the first through fourth doping regions 311 through 314 may be connected to an upper layer via contacts. The first through fourth doping regions 311 through 314 may be connected in common at the upper layer.

As illustrated in FIGS. 15, word lines disposed at the same height may be connected in common. Thus, when a word line disposed at a specific height is selected and all NAND strings connected with the selected word line may be selected. NAND strings in different rows may be connected to different string selection lines. Thus, NAND strings in an unselected row from among NAND strings connected with the same word line may be separated from a corresponding bit line by selecting the string selection lines SSL1 through SSL3. That is, a row of NAND strings may be selected by selecting and unselecting the string selection lines SSL1 through SSL3. A column of NAND strings in a selected row may be selected by selecting bit lines BL1 through BL3.

The three dimensional non-volatile memory device has more and more error bits because three dimensional non-volatile memory device has lager block size and less reliable memory cells than planar non-volatile memory device. Memory controller 1200 may improve reliability of non-volatile memory device by changing the order of unit data.

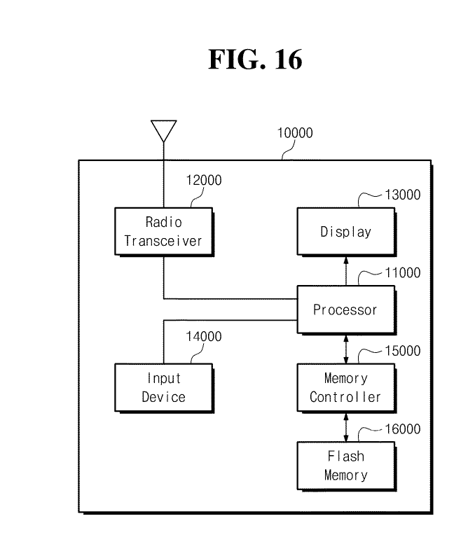

FIG. 16 is a block diagram illustrating an electronic device 10000 comprising a non-volatile memory device according to an embodiment of inventive concept.

Referring to FIG. 16, electronic device 10000, such as a cellular phone, a smart phone, or a tablet PC comprises a non-volatile memory device 16000 formed of a flash memory device and a memory controller 15000 controlling an operation of non-volatile memory device 16000.

Non-volatile memory device 16000 may correspond to a non-volatile memory device described in relation to FIG. 1, for example. Non-volatile memory device 16000 may be configured to verify programming of first data pattern using a first memory cell storing the first data pattern, a second memory cell programmed using a program voltage, and a verification voltage corresponding to the first data pattern. When a verification result of the first memory cell indicates a pass, programming of the second memory cell may be ended.

Memory controller 15000 may correspond to a memory controller illustrated in FIG. 1. Memory controller 15000 may be controlled by a processor 11000 controlling an overall operation of electronic device 10000.

Data stored in non-volatile memory device 16000 may be displayed via a display 13000 under the control of memory controller 15000 that operates in response to the control of a processor 11000. A radio transceiver 12000 may transmit and receive a radio signal via an antenna. For example, radio transceiver 12000 may convert a radio signal received via the antenna to a signal suitable for processor 11000 to process. Processor 11000 may process a signal output from radio transceiver 12000, and the processed signal may be stored in non-volatile memory device 16000 via memory controller 15000 or displayed via display 13000. Radio transceiver 12000 may convert a signal from processor 11000 to a radio signal to output it to an external device via the antenna. An input device 14000 may be a device capable of receiving a control signal for controlling an operation of processor 11000 or data to be processed by processor 11000. Input device 14000 may include a pointing device such as a touch pad or a computer mouse, a keypad, or a keyboard. Processor 11000 may control display 13000 so as to display output data from non-volatile memory device 16000, a radio signal from radio transceiver 12000, or data from input device 14000.

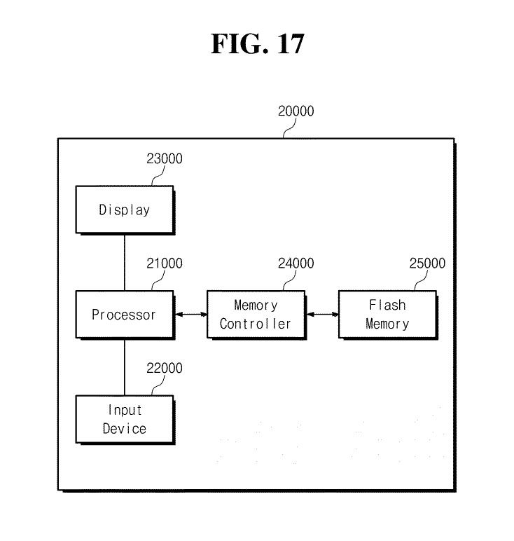

FIG. 17 is a block diagram illustrating an electronic device 20000 comprising a memory controller and a non-volatile memory device according to an embodiment of inventive concept.

Referring to FIG. 17, electronic device 20000 may be a data processing device such as a personal computer, a tablet computer, a net-book, an e-reader, a PDA, a PMP, an MP3 player, or an MP4 player, and may include a non-volatile memory device 25000 such as a flash memory device and a memory controller 24000 controlling an operation of non-volatile memory device 25000. Non-volatile memory device 25000 may correspond to a non-volatile memory device described in relation to FIGS. 1. Non-volatile memory device 25000 may be configured to verify programming of first data pattern using a first memory cell storing the first data pattern, a second memory cell programmed using a program voltage, and a verification voltage corresponding to the first data pattern. When a verification result of the first memory cell indicates a pass, programming of the second memory cell may be ended.

Memory controller 24000 may correspond to a memory controller illustrated in FIG. 1. Electronic device 20000 comprises a processor 21000 controlling an overall operation of electronic device 20000. Memory controller 24000 may be controlled by processor 21000.

Processor 21000 may display data stored in a non-volatile memory device via a display according to an input signal generated by an input device 22000. For example, input device 22000 may be formed of a pointing device such as a touch pad or a computer mouse, a keypad, or a keyboard.

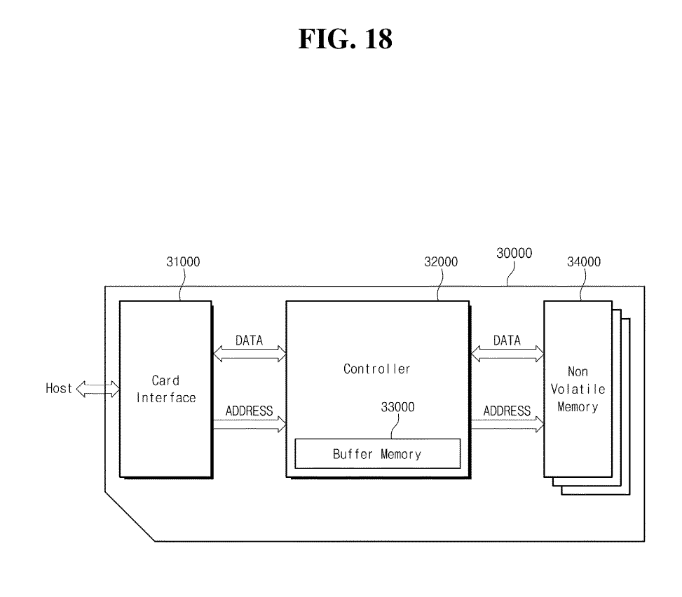

FIG. 18 is a block diagram illustrating an electronic device 3000 comprising a non-volatile memory device according to an embodiment of inventive concept.

Referring to FIG. 18, electronic device 30000 comprises a card interface 31000, a memory controller 32000, and at least one non-volatile memory device 34000, for example, a flash memory device.

Electronic device 30000 exchanges data with a host via card interface 31000. In some embodiments, card interface 31000 may be an SD card interface or an MMC interface, although embodiments of inventive concept are not limited thereto. Card interface 31000 may exchange data between the host and memory controller 32000 according to the communication protocol of the host capable of communicating with electronic device 30000.

Memory controller 32000 may control an overall operation of electronic device 30000, and may control data exchange between card interface 31000 and non-volatile memory device 34000. A buffer memory 33000 of memory controller 32000 may buffer data transferred between card interface 31000 and the at least one non-volatile memory device 34000.

Memory controller 32000 is connected to card interface 31000 and non-volatile memory device 34000 via a data bus and an address bus. In some embodiments, memory controller 32000 receives an address of data to be read or written via the address bus from card interface 31000 to send it to the at least one non-volatile memory device 34000. Memory controller 32000 receives or sends data to be read or to be written via the data bus connected to card interface 31000 or the at least one non-volatile memory device 34000.

The at least one non-volatile memory device 34000 may correspond to a non-volatile memory device described in relation to FIGS. 1. The at least one non-volatile memory device 34000 may be configured to verify programming of first data pattern using a first memory cell storing the first data pattern, a second memory cell programmed using a program voltage, and a verification voltage corresponding to the first data pattern. Where a verification result of the first memory cell indicates a pass, programming of the second memory cell may be ended. Memory controller 32000 may correspond to a memory controller illustrated in FIG. 1.

Where electronic device 30000 in FIG. 18 is connected to a host such as a PC, a tablet PC, a digital camera, a digital audio player, a cellular phone, a console video game hardware, or a digital set-top box, the host may send or receive data stored in non-volatile memory device 34000 via card interface 31000 and memory controller 32000.

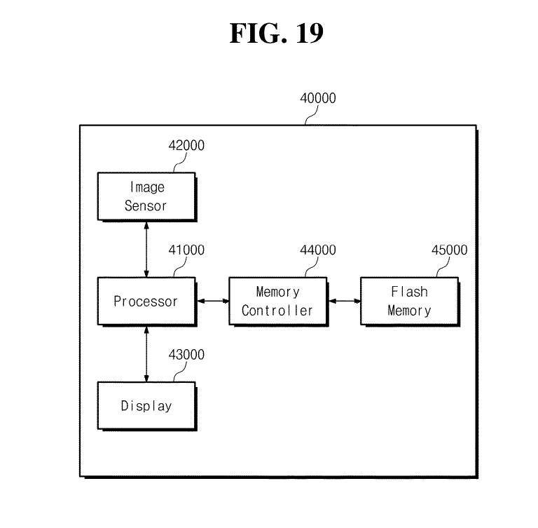

FIG. 19 is a block diagram illustrating an electronic device 40000 comprising a memory controller and a non-volatile memory device according to an embodiment of inventive concept.

Referring to FIG. 19, electronic device 40000 comprises a non-volatile memory device 45000 such as a flash memory device, a memory controller 44000 controlling a data processing operation of non-volatile memory device 45000, and a processor 41000 controlling an overall operation of electronic device 40000.

Non-volatile memory device 45000 may correspond to a non-volatile memory device described in relation to FIGS. 1, for example. Non-volatile memory device 45000 may be configured to verify programming of first data pattern using a first memory cell storing the first data pattern, a second memory cell programmed using a program voltage, and a verification voltage corresponding to the first data pattern. Where a verification result of the first memory cell indicates a pass, programming of the second memory cell may be ended. Memory controller 44000 may correspond to a memory controller illustrated in FIG. 1.

An image sensor 42000 of electronic device 40000 converts an optical signal to a digital signal, and the digital signal is stored in non-volatile memory device 45000 or displayed via a display 43000 under the control of processor 41000.

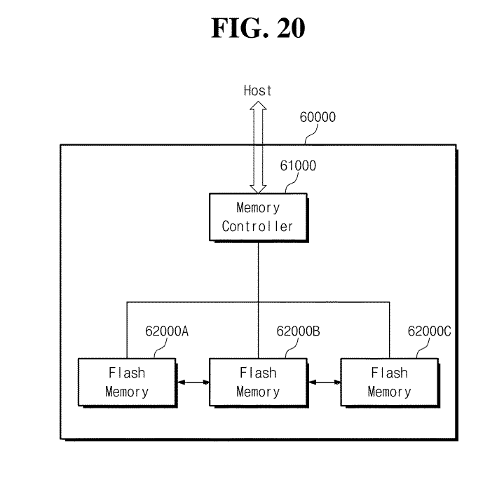

FIG. 20 is a block diagram illustrating an electronic device 60000 comprising a memory controller and non-volatile memory devices according to an embodiment of inventive concept. Electronic device 60000 may be implemented by a data storage device such as a Solid State Drive (SSD).

Referring to FIG. 20, electronic device 60000 comprises multiple non-volatile memory devices 62000A, 62000B, and 62000C, and a memory controller 61000 controlling a data processing operation of each of the non-volatile memory devices 62000A, 62000B, and 62000C. Electronic device 60000 may be implemented by a memory system or a memory module.

Each of non-volatile memory devices 62000A, 62000B, and 62000C may be a non-volatile memory device described in FIG. 1. Each of non-volatile memory devices 62000A, 62000B, and 62000C may be configured to verify programming of first data pattern using a first memory cell storing the first data pattern, a second memory cell programmed using a program voltage, and a verification voltage corresponding to the first data pattern. Where a verification result of the first memory cell indicates a pass, programming of the second memory cell may be ended. Memory controller 61000 may correspond to a memory controller illustrated in FIG. 1. In general, memory controller 61000 may be provided at the interior or exterior of electronic device 60000.

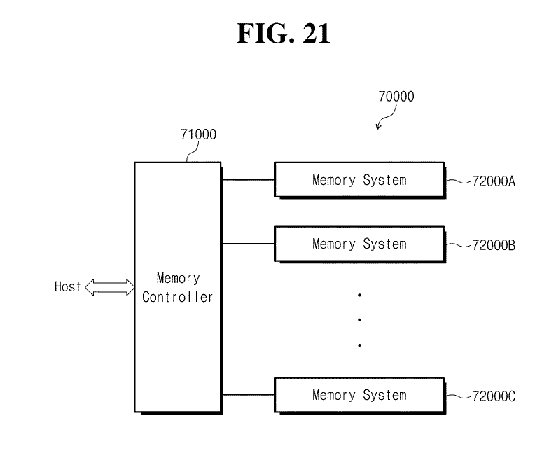

FIG. 21 is a block diagram illustrating a data processing system including an electronic device in FIG. 20.

Referring to FIGS. 20 and 21, a data storage device 70000 may be implemented by a Redundant Array of Independent Disks (RAID) system, and may include a RAID controller 71000 and multiple memory systems 72000A to 72000C.

Memory systems 72000A to 72000C may be an electronic device 60000 illustrated in FIG. 20. Memory systems 72000A to 72000C may constitute a RAID array. Data storage device 70000 may be implemented by a personal computer or an SSD.

During a program operation, RAID controller 71000 may output program data from a host to one of memory systems 72000A to 72000C according to a RAID level, selected depending on RAID level information from the host, from among multiple RAID levels.

During a read operation, RAID controller 71000 may provide the host with read data from one of memory systems 72000A to 72000C according to a RAID level, selected depending on RAID level information from the host, from among multiple RAID levels.

The foregoing is illustrative of embodiments and is not to be construed as limiting thereof. Although a few embodiments have been described, those skilled in the art will readily appreciate that many modifications are possible in the embodiments without departing from the scope of the inventive concept as defined in the claims.

1. A method of operating a memory controller, comprising:
receiving original data from an external source;
partitioning the original data into multiple elements of unit data;
changing an order of at least one element of unit data to reduce the number of occurrences of a target state among the multiple units of unit data; and
controlling a non-volatile memory device to program the multiple elements of unit data having the reduced number of occurrences of the target state.

2. The method of claim 1, wherein the original data is error correction code (ECC) encoded data.

3. The method of claim 1, wherein the original data is randomized data.

4. The method of claim 1, wherein the unit data sector unit data that is an error correction code (ECC) operation unit.

5. The method of claim 1, wherein the unit data is page unit data for a program or read operation.

6. The method of claim 1, the method wherein the unit data is randomizing operation unit data.

7. The method of claim 1, wherein the target state is a uppermost programmed state.

8. The method of claim 1, further comprising:
performing a state shaping operation on the multiple elements of unit data after changing the order of the at least one element of unit data.

9. The method of claim 1, further comprising:
performing a state shaping operation after changing an order of unit data.

10. The method of claim 1, wherein changing the order of at least one unit data is performed based on the number of target states.

11. The method of claim 1, wherein changing the order of at least one unit data is performed based on the number of occurrences of a bit value among the multiple elements of unit data.

12. A method of operating a memory controller that controls a multi-level cell (MLC) non-volatile memory device, the method comprising:
receiving original data from an external source;
partitioning the original data into multiple units of page data;
selecting the units of page data and combining the selected units to reduce a number of target data patterns among the units of page data; and
controlling the non-volatile memory device to program the combined units of page data.

13. The method of claim 12, wherein when the MLC non-volatile memory device is a 4-bit MLC non-volatile memory device, and 4 units of page data are selected and combined.

14. The method of claim 12, wherein the original data comprises at least four types of page data.

15. The method of claim 12, further comprising performing a state shaping operation on the units of page data before selecting the units of page data.

16. The method of claim 12, wherein a non-volatile memory device comprises a memory cell array stacked on substrate and comprising multiple blocks.

17. The method of claim 12, further comprising performing a page mapping operation using combined page data.

18. A method of operating a memory controller that controls a three dimensional non-volatile memory device, comprising:
partitioning original data from a host into multiple units of page data;
rearranging an order of the page data to reduce the number of occurrences of a target data pattern; and
providing the non-volatile memory device with the rearranged page data.

19. The method of claim 18, wherein the rearranging of the order of the page data is based on a first and a second page data pattern.

20. The method of claim 18, further comprising performing a state shaping operation using rearranged page unit data.

21-30. (canceled)
